(19) United States
(12) Patent Application Publication
(10) Pub. No.: US 2015/0281784 A1
(43) Pub. Date: Oct. 1, 2015

(54) E-READING SYSTEM WITH INTEREST-BASED RECOMMENDATIONS AND METHODS FOR USE THEREWITH

(71) Applicant: ViXS Systems, Inc., Toronto (CA)

(72) Inventors: INDRA LAKSONO, RICHMOND HILL (CA); JOHN POMEROY, MARKHAM (CA); SALLY JEAN DAUB, TORONTO (CA); XU GANG ZHAO, MAPLE (CA)

(73) Assignee: ViXS Systems, Inc., Toronto (CA)

(21) Appl. No.: 14/679,490

(22) Filed: Apr. 6, 2015

Related U.S. Application Data
(63) Continuation-in-part of application No. 14/669,876, filed on Mar. 26, 2015.
Application No. 14/669,876 is a continuation-in-part of application No. 14/590,303, filed on Jan. 6, 2015.
Application No. 14/590,303 is a continuation-in-part of application No. 14/217,867, filed on Mar. 18, 2014.
Application No. 14/217,867 is a continuation-in-part of application No. 14/477,064, filed on Sep. 4, 2014.

(51) Int. Cl. H04N 21/466; H04N 21/81; H04N 21/442

(52) U.S. Cl. CPC H04N 21/4668; H04N 21/44218; H04N 21/4667; H04N 21/812; H04N 21/8133

(57) ABSTRACT

A user interest analysis generator analyzes input data corresponding to a viewing of the media file by the viewer, to determine a period of interest of the viewer and to generate viewer interest data that indicates the period of interest. A recommendation selection generator configured to process the viewer interest data to automatically generate recommendation data indicating at least one additional media file related to content of the media file being displayed during the period of interest, for display to the viewer by a display device associated with an e-reader.

### CROSS REFERENCE TO RELATED PATENTS

The present U.S. Utility patent application claims priority pursuant to 35 U.S.C. §120 as a continuation-in-part of U.S. Utility application Ser. No. 14/669,876 entitled “AUDIO/VIDEO SYSTEM WITH INTEREST-BASED RECOMMENDATIONS AND METHODS FOR USE THEREWITH”, filed Mar. 26, 2015, which is a continuation-in-part of U.S. Utility application Ser. No. 14/590,303, entitled “AUDIO/VIDEO SYSTEM WITH INTEREST-BASED AD SELECTION AND METHODS FOR USE THEREWITH”, filed Jan. 6, 2015, which is a continuation-in-part of U.S. Utility application Ser. No. 14/217,867, entitled “AUDIO/VIDEO SYSTEM WITH USER ANALYSIS AND METHODS FOR USE THEREWITH”, filed Mar. 18, 2014, and claims priority pursuant to 35 U.S.C. §120 as a continuation-in-part of U.S. Utility application Ser. No. 14/477,064, entitled “VIDEO SYSTEM FOR EMBEDDING EXCITEMENT DATA AND METHODS FOR USE THEREWITH”, filed Sep. 4, 2014, all of which are hereby incorporated herein by reference in their entirety and made part of the present U.S. Utility Patent Application for all purposes.

### TECHNICAL FIELD

The present disclosure relates to e-readers and similar devices that process and present books and other media for display.

### DESCRIPTION OF RELATED ART

E-readers have become popular consumer goods. An e-reader includes a display that allows the user to read or otherwise view the media, without flipping pages. Discounts on the cost of the media are frequently available given the lower cost of production and distribution compared with ordinary print media—allowing users to obtain books at reduced cost. Further, the low cost of digital storage allows must e-readers to store an entire library of the user's books in a single location to be accessed at any time.

Many publishers have embraced this trend and a large assortment of books, magazines, newspapers and other print media are available to be downloaded to an e-reader. With almost instant availability of such a wide variety of materials, many users are at a loss to determine which media to choose.

### BRIEF DESCRIPTION OF THE SEVERAL VIEWS OF THE DRAWINGS

FIGS. 1-3 present pictorial diagram representations of various devices in accordance with embodiments of the present disclosure.

FIG. 4 presents a block diagram representation of a system 125 in accordance with an embodiment of the present disclosure.

FIG. 5 presents a pictorial representation of a screen display 150 in accordance with an embodiment of the present disclosure.

FIG. 6 presents a pictorial representation of a screen display 160 in accordance with an embodiment of the present disclosure.

FIG. 7 presents a pictorial representation of a screen display 170 in accordance with an embodiment of the present disclosure.

FIG. 8 presents a pictorial representation of a video image in accordance with an embodiment of the present disclosure.

FIG. 9 presents a graphical diagram representation of interest data in accordance with an embodiment of the present disclosure.

FIGS. 10 and 11 present pictorial diagram representations of components of a system in accordance with embodiments of the present disclosure.

FIGS. 12 and 13 present pictorial diagram representations of systems in accordance with embodiments of the present disclosure.

FIG. 14 presents a flowchart representation of a method in accordance with an embodiment of the present disclosure.

### DETAILED DESCRIPTION

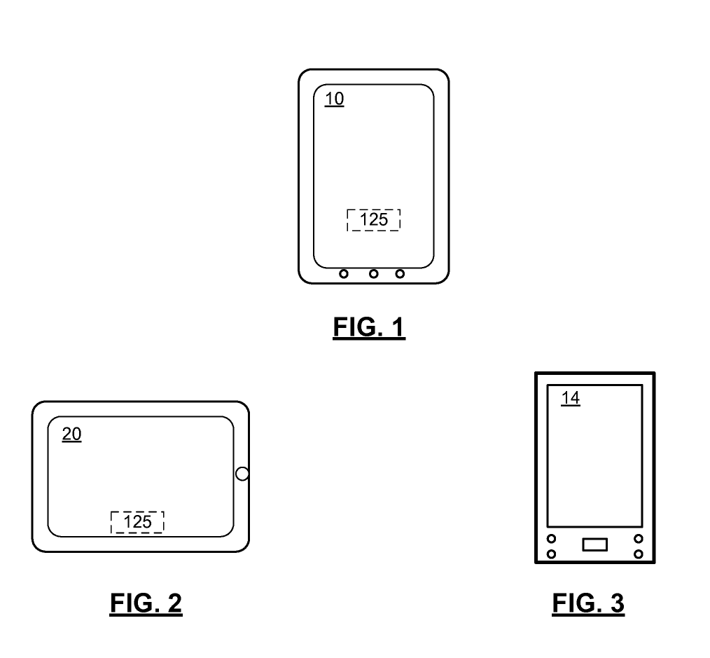

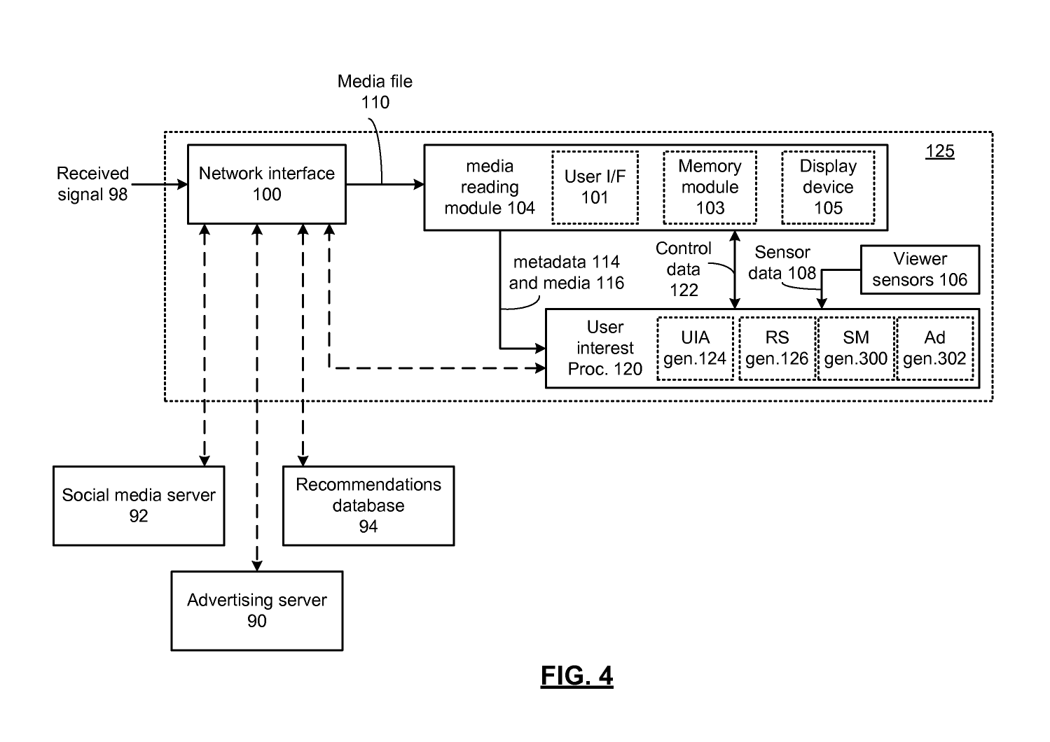

FIGS. 1-3 present pictorial diagram representations of various video devices in accordance with embodiments of the present disclosure. In particular, device 10 represents an e-reader, also called or e-book device. The e-reader 10 is a mobile electronic device that is designed primarily for the purpose of reading digital e-books and periodicals. The e-reader 10 includes a dedicated e-reader application or other software that supports e-reading activities. The e-reader 10 includes e-readers designed to optimize portability, readability (especially in sunlight), and battery life for the purpose of reading books, periodicals and other media.

While described in conjunction with a special purpose device, other devices that can display text and/or graphics on a screen and operate as an e-reader. Device 20 represents a tablet computer, netbook or other portable computer that can operate as an e-reader or other media reading or viewing module via an e-reader app that is downloaded to the device or other hardware or software. Device 14 represents a smartphone, phablet or other communications device that can operate as an e-reader via an e-reader app or other software that can be wirelessly downloaded to the device.

The devices 10, 14 and 20 each represent examples of electronic devices that incorporate one or more elements of a system 125 that includes features or functions of the present disclosure. While these particular devices are illustrated, system 125 includes any device or combination of devices that is capable of performing one or more of the functions and features described in conjunction with FIGS. 4-14 and the appended claims.

FIG. 4 presents a block diagram representation of a system in accordance with an embodiment of the present disclosure. In an embodiment, system 125 includes a network interface 100, such as an Ethernet connection, Universal Serial Bus (USB) connection, Bluetooth interface, 3G or 4G transceiver and/or other information receiver or transceiver or network interface that is capable of receiving a received signal 98 and extracting one or more media files 110. In an embodiment the media file 110 includes an electronic book or ebook in a digital media format such as a PDF, Open eBook, HTML, XML, EPUB or other digital format that includes text and optionally graphics and associated video or audio.

In addition to receiving the received signal 98, the network interface 100 can provide an Internet connection, local area network connection or other wired or wireless connection to a recommendations database 94, advertising server 90, social media server and/or to other sources and devices. While shown as a single device, network interface 100 can be implemented by two or more separate devices, for example, to receive the received signal 98 via one network and to communicate with recommendations database 94, advertising server 90, social media server 92 via one or more other networks.

The media reading module 104 includes a user interface 101 such as a touch screen, touch pad or one or more buttons or other devices that allow the user to interact with the device to, for example select media files to download via the network interface 100 and to store these media files 110 in the memory module 103. The user interface 101 also allows a user to select media files 110 to retrieve from the memory module for display on the display device 105 and to navigate through a particular media file 110 to facilitate the reading or other viewing the pages or other portions of an ebook. Currently, Amazon.com and others create customized recommendations for books. They look at what books were read by a user and generic info like genre, author, etc. to similar books. The problem is, they don't really know if a reader liked a book and they don't really know what portions of the book that the reader liked.

The system 125 includes a user interest processor 120 for use with the media reading module 104 that is displaying a particular media file 110 for viewing by a viewer/user of the system 125. The user interest processor 120 includes a user interest analysis generator 124 that is configured to analyze input data corresponding to a viewing/reading of the media file by the viewer, to determine a period of interest of the viewer and to generate viewer interest data that indicates the period of interest. A recommendation selection generator 126 processes the viewer interest data to automatically generate recommendation data indicating at least one additional media file related to content of the media file 110 being displayed during the period of interest, for display to the viewer by a display device associated with the media reading module 104.

Unlike current systems, the user interest analysis generator 124 can be used to identify precise content features that are of interest to a particular viewer/reader to be used to generate the customized recommendations via recommendation selection generator 126. The recommendation selection generator 126 of the user interest processor 120 can process the viewer interest data and metadata 114 and/or portions of the media 116 corresponding to the content of the media file 110 being currently displayed to automatically generate recommendation data. Because actual interest is monitored and correlated to particular content of the media file 110 being displayed at that time, a more precise selection of features can be extracted and used to generate recommendations. Non-featured characters of interest, fleeting situations relating to a particular place or setting or a particular activity, and/or subjects related to only a portion of a media file such as the subject of a magazine or newspaper article, can be used to locate recommendations that are more focused on these features of interest that occur in particular portions of the media file 110.

The recommendation data can be presented for display to the viewer by a display device, such as the display device 105 associated with the media reading module 104. For example, the display device 105 can concurrently display at least a portion of the video program in conjunction with the recommendations data in a split screen mode, as a graphical or other media overlay or in other combinations during the display of the media file 110 or after the viewer has completely viewed the media file 110 or has otherwise suspended viewing, whether temporarily or not.

In an embodiment, the user interest processor 120 operates based on input data that includes image data in a presentation area of the display device 105. For example, a viewer sensor 106 generates sensor data 108 in a presentation area of the display device 105. The viewer sensor 106 can include a digital camera such as a still or video camera that is either a stand-alone device, or is incorporated in any one of the devices 10, 14 or 20 or other device that generates sensor data 108 in the form of image data. In addition or in the alternative, the viewer sensor 106 can include an infrared sensor, thermal imager, background temperature sensor or other thermal sensor, an ultrasonic sensor or other sonar-based sensor, a proximity sensor, an audio sensor such as a microphone, a motion sensor, brightness sensor, wind speed sensor, humidity sensor, one or more biometric sensors and/or other sensors for generating sensor data 108 that can be used by the user interest analysis generator 124 for determining that the viewer is currently interested in the content of the media file 110 and for generating viewer interest data in response thereto.

In an embodiment, the user interest analysis generator 124 determines a period of interest corresponding to viewer based on facial modeling and recognition that the viewer has a facial expression corresponding to interest. In addition, the input data can include audio data from a viewer sensor 106 in the form of a microphone included in in a presentation area of the media reading module 104. The user interest analysis generator 124 can determine a period of interest corresponding to the viewer based on recognition that utterances by the viewer correspond to interest. An excited voice from a viewer can indicate interest, while a side conversation unrelated the content or snoring can indicate a lack of interest.

In another embodiment, the input data can include A/V control data 122 that includes commands from the media reading module 104 such as a pause command, an annotation command, commands that indicate that a viewer has re-read or reviewed a portion more than once, or a specific user interest command that is generated in response to commands issued by a user/viewer via a user interface of the media reading module 104. The user interest analysis generator 124 can determine a period of interest based on pausing of the display—i.e. when a page has been presented for more than a predetermined threshold amount of time, and/or in response to a specific user indication of interest via another command.

For example, when a viewer is interested in a particular portion of the book and has either re-read the pages corresponding to this portion, paused to read this portion for more than an ordinary length of time, annotated this portion via interaction with the user interface 101, or provides a command via the user interface 101 that specifically indicates that the portion is “liked”, input data in the form of control data 122 is presented to the user interest processor 120. In response, the user interest analysis generator 124 indicates a period of interest. The recommendation selection generator 126 analyzes the metadata 114 or the portions of the media 116 being displayed to determine the characters, scenes, places, situations, objects etc. that indicate the content of the media file that are currently being displayed.

Some metadata 114 can be included in the media file 110 when received by the media reading module 104. Examples of such metadata 114 include standard highlighting, comments or other annotations, highlighting, comments or other annotations by other users, general genre, character lists as well as specific metadata that is correlated to particular portions of the media file 110. In addition, the metadata 114 can include other metadata generated by the user of the media reading module 104 such as highlighting, comments or other annotations by the user himself or herself. The recommendation selection generator 126 can then generate media recommendations, such as books, magazines or individual articles pertaining to the characters, places, and/or situation occurring at that point in the current book, magazine or article.

Consider an example where a user is reading an article in the Washington Post regarding global warming—and shows interest that is detected by the user interest analysis generator 124. The recommendation selection generator 126 can respond by analyzing the media 116 and metadata 114 corresponding to the article being currently read to determine that the article is about global warming. The recommendation selection generator 126 can then search a remote recommendations database 94 for additional books and articles regarding global warming that are used to generate recommendation data for display that includes these recommendations. This recommendation data can be passed to the media reading module 104 as control data 122 for display on the display device 105 while the article is being read or after the user has finished reading of the article.

In another embodiment, the input data includes sensor data 108 from at least one biometric sensor associated with the viewer. The user interest analysis generator 124 determines a period of interest corresponding to the viewer or viewers based on recognition that the sensor data 108 indicates interest of the viewer. Such biometric sensor data 108 in response to, or that otherwise indicates, the interest of the user—in particular, the user's interest in the current content of the media file being displayed by the media reading module 104. In an embodiment, the viewer sensors 106 can include an optical sensor, resistive touch sensor, capacitive touch sensor or other sensor that monitors the heart rate and/or level of perspiration of the user. In these embodiments, a high level of interest can be determined by the user interest analysis generator 124 based on a sudden increase in heart rate or perspiration.

In an embodiment, the viewer sensors 106 can include a microphone that captures the voice of the viewer. In particular, the voice of the user can be analyzed by the user interest analysis generator 124 based on speech patterns such as pitch, cadence or other factors and/or cheers, applause, excited utterances such as “wow” or other sounds that can be analyzed to detect a high level of interest by the reader/viewer.

In an embodiment, the viewer sensors 106 can include an imaging sensor or other sensor that generates a biometric signal that indicates a dilation of an eye of the user and/or a wideness of opening of an eye of the user. In these cases, a high level of user interest can be determined by the user interest analysis generator 124 based on a sudden dilation of the user's eyes and/or based on a sudden widening of the eyes. It should be noted that multiple viewer sensors 106 can be implemented and the user interest analysis generator 124 can generate interest data based on an analysis of the sensor data 108 from each of multiple viewer sensors 106. In this fashion, periods of time corresponding to high levels of interest can be more accurately determined based on multiple different criteria.

Consider an example where a reader is reading Harry Potter. A sudden increase in heart rate, perspiration, eye wideness, pupil dilation, smile, changes in voice and excited utterances may together or separately indicate that the reader has suddenly become highly interested in what is happening in the book. This period of interest can be used generate recommendation data as to other books or articles that relate to the particular characters, places, events or situations, and/or objects that are present in the portion of the book that is currently being displayed.

In an embodiment, the user interest analysis generator 124 operates to identify the particular user/viewer based on input data such as: (1) voice or face recognition of the user; (2) fingerprint recognition on any remote input device such as a remote control; or (3) via user password, explicit choice by user on self-identification, etc. The media file 110 can be viewed by the system 125 at different times and by different users. The user interest analysis generator 124 can recognize the viewer each time and extract interest information for multiple different viewers of the same content via the system 125, e.g. dad liked the action, mom liked the romance, daughter really liked the boy next door character.

In one mode of operation, the recommendation selection generator 126 is a self-learning system, so for example, it can ship with a default set of rules based on known subscriber demographics and/or geographical location derived from GPS or any location services available. The system 125 can, over time, collect profile data for each unique user of the system 125 by identifying unique users as described previously and storing data regarding their interests. In this fashion, the profile data for a particular viewer could start with general user demographic data and then be customized into a profile for each user. With each use by each user/viewer, the system will learn what each individual user and modifies profiles used by the recommendation selection generator 126 to match the history of choices associated with each user.

In addition, the profile data for each user can include a social media account. The posts, profile and other data from the social media account can be retrieved via the network interface 100 from the social media server 92 and also used to supplement the likes, dislikes and other profile data of individual users. In this fashion, the user/viewer profile of the current user can also be used by recommendation selection generator 126 in additional to the information garnered from the content of the media file currently being displayed in order to select more pertinent recommendations for that particular user.

In an embodiment, the recommendation selection generator 126 implements a clustering algorithm, a heuristic prediction engine and/or artificial intelligence engine that operates in conjunction with a recommendations database 94 and optionally profile data collected and stored that pertains to one or more viewers of one or more media files 110. In addition, the recommendation selection generator 126 selects one or more additional media files to recommend based on metadata 114 and/or portions of media 116 being displayed, such as characters, places, situations, genres, objects, etc. that are presented in the video media and determined to be of interest to the viewer by the user interest analysis generator 124.

When the metadata 114 or media 116 indicates a character, place, situation or activity in a media file being read or otherwise viewed during the period of interest to a viewer, the recommendation selection generator 126 can identify at least one additional media file to recommend to the viewer by searching the recommendation database 94 for recommendations based on the identification of that character place, situation or activity. For example, when the metadata 114 or media 116 indicates an character (either fictional or non-fictional) in the media during the period of interest to a viewer (e.g. Tony Blair, Prince William, Bruce Lee, Wayne Gretzky, David Beckham, Huck Finn, Tom Sawyer, Harry Potter, Hercule Poirot, Miss Marple, Perry Mason, Captain Aubrey, Horatio Hornblower, etc.) the recommendation selection generator 126 can identify at least one additional media file to recommend to the viewer by searching the recommendation database 94 for other works that contain that character. When the metadata 114 or media 116 indicates a situation or activity (e.g., skiing, candlelight dinners, football, love scenes, action, global warming, the war of 1812, masonic rites, economic collapse, etc.) in the media during the period of interest to a viewer, the recommendation selection generator 126 can identify at least one additional media file to recommend to the viewer by searching the recommendation database 94 based on such a situation or activity. When the metadata 114 or media 116 indicates a place or setting (e.g. Paris, the Eiffel Tower, the Grand Bazaar in Istanbul, the Orient Express, Ephesus, Hillsborough Stadium, a misty moor, a castle in Wales, a lake house in Ontario, Air Force One, etc.) in the media file 110 during the period of interest to a viewer, the recommendation selection generator 126 can identify at least one additional media file to recommend to the viewer by searching the recommendation database 94 based on such a situation or activity.

In an embodiment, the user interest processor 120 further includes a social media generator 300 configured to process viewer interest data and to automatically generate a social media post, corresponding to the content of the media file during the period of interest, for posting to a social media account associated with the viewer. In one mode of operation, the user interest processor 120 responds to periods of interest and communicates via network interface 100 with a social media server 92 to automatically generate posts relating to the content of media file that correlates to the viewer interest. The social media generator 300 can forward the social media post to the social media server 92 via the network interface 100, in response to user input that indicates that the social media post is accepted by the viewer.

In an embodiment, the social media post is presented on the display device 105 and the display device 105 concurrently displays at least a portion of media file 110 in conjunction with the social media post. In addition or in the alternative, the social media post can be transmitted via network interface 100 for display on a display device associated with another portable device associated with the viewer.

In an embodiment, the user interest processor 120 further includes an ad selection generator 302 configured to process the viewer interest data to automatically retrieve an advertisement from a remote ad server 90 corresponding to the content of the media file during the period of interest, for display to the viewer by a display device, such as display device 105.

The media reading module 104 and the user interest processor 120 can each be implemented using a single processing device or a plurality of processing devices. Such a processing device may be a microprocessor, co-processors, a micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions that are stored in a memory. These memories may each be a single memory device or a plurality of memory devices. Such a memory device can include a hard disk drive or other disk drive, read-only memory, random access memory, volatile memory, non-volatile memory, static memory, dynamic memory, flash memory, cache memory, and/or any device that stores digital information. Note that when media reading module 104 and the user interest processor 120 implement one or more of their functions via a state machine, analog circuitry, digital circuitry, and/or logic circuitry, the memory storing the corresponding operational instructions may be embedded within, or external to, the circuitry comprising the state machine, analog circuitry, digital circuitry, and/or logic circuitry.

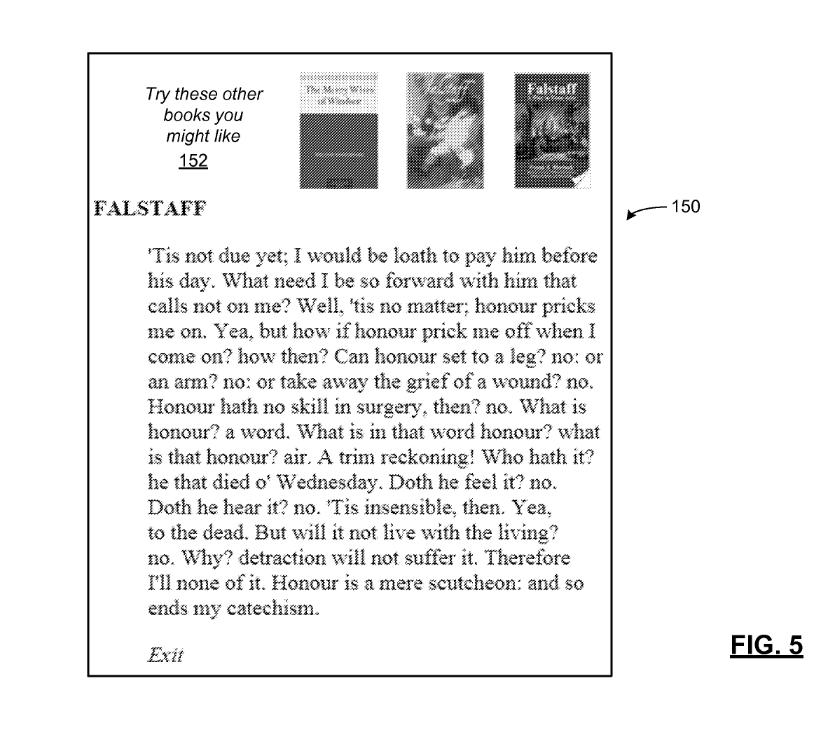

While the recommendations database 94 is shown separately from the system 125, the recommendations database 94 can be incorporated in the user interest processor 120. While system 125 is shown as an integrated system, it should be noted that the system 125 can be implemented as a single device or as a plurality of individual components that communicate with one another wirelessly and/or via one or more wired connections. The further operation of video system 125, including illustrative examples and several optional functions and features is described in greater detail in conjunction with FIGS. 5-14 that follow.

FIG. 5 presents a pictorial representation of a screen display 150 in accordance with an embodiment of the present disclosure. In particular, a screen display 150 presented by display device 105 is generated in conjunction with a system, such as system 125, that is described in conjunction with functions and features of FIG. 4 that are referred to by common reference numerals.

In the example shown, a user/viewer of the system 125 is reading Shakespeare's play, “Henry IV”. The user has paused to read a portion of the play that presents a soliloquy regarding the nature of honor (honour). The user interest analysis generator 124 analyzes input data such as control data 122 and sensor data 108 to determine that the user has paused to re-read this section several times and/or is otherwise displaying signs of heightened interest. The recommendations selection generator 126 responds to this period of interest, analyzes the content of the media 116 being displayed and corresponding metadata 114 to determine that this section relates to a famous passage regarding the character John Falstaff. The recommendations selection generator 126 searches the recommendations database 94 for other John Falstaff related material that might match with the profile of the particular user (in this case, a young college student in Derby that has read many of the classics), and generates the particular recommendations 152—in this case, Shakespeare's play, “The Merry Wives of Windsor”, and two other novels by other authors that feature Falstaff as a more featured character.

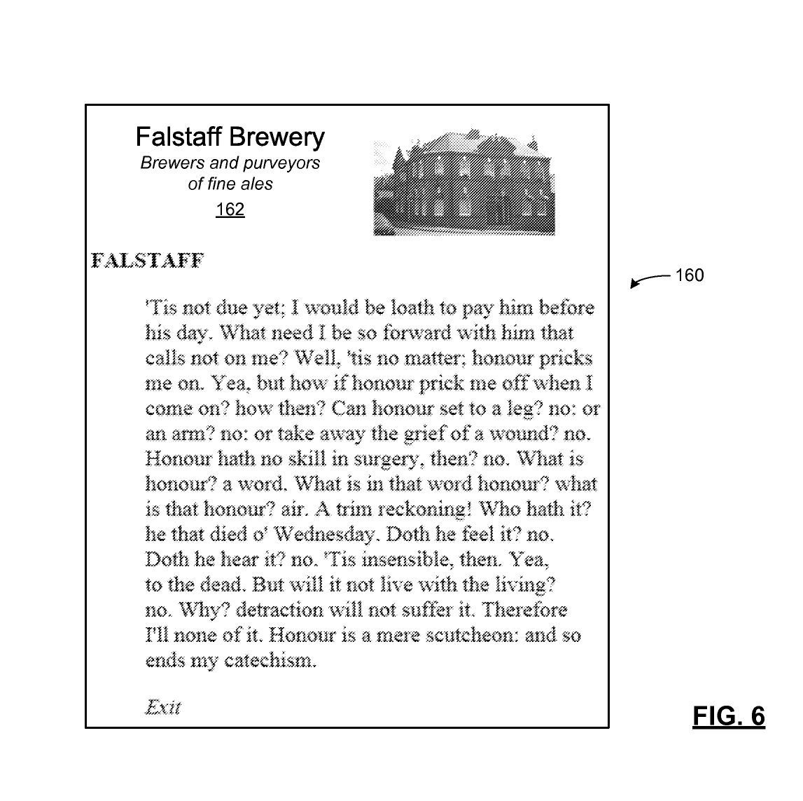

FIG. 6 presents a pictorial representation of a screen display 160 in accordance with an embodiment of the present disclosure. In particular, a screen display 160 presented by display device 105 is generated in conjunction with a system, such as system 125, that is described in conjunction with functions and features of FIG. 4 that are referred to by common reference numerals—in addition to the example presented in conjunction with FIG. 5.

As previously discussed, the user interest analysis generator 124 analyzes input data such as control data 122 and sensor data 108 to determine that the user has paused to re-read this section several times and/or is otherwise displaying signs of heightened interest. The advertising generator 302 responds to this period of interest, analyzes the content of the media 116 being displayed and corresponding metadata 114 to determine that this section relates to a famous passage regarding the character John Falstaff. The advertising generator 302 searches the advertising server 90 for other John Falstaff related material that might match with the profile of the particular user (in this case, a young college student in Derby that has read many of the classics), and generates the particular recommendations 162—in this case, an advertisement for Falstaff Brewery.

FIG. 7 presents a pictorial representation of a screen display 170 in accordance with an embodiment of the present disclosure. In particular, a screen display 170 presented by display device 105 is generated in conjunction with a system, such as system 125, that is described in conjunction with functions and features of FIG. 4 that are referred to by common reference numerals that are referred to by common reference numerals—in addition to the example presented in conjunction with FIG. 5.

As previously discussed, the user interest analysis generator 124 analyzes input data such as control data 122 and sensor data 108 to determine that the user has paused to re-read this section several times and/or is otherwise displaying signs of heightened interest. The social media generator 300 responds to this period of interest, analyzes the content of the media being displayed and corresponding metadata to determine that this relates to a famous passage regarding the character John Falstaff. The social media generator 300 generates the social media post 172—in this case, a social media post associated with the particular user/viewer that indicates an interest in Falstaff for review and approval by the user and posting via social media server 92.

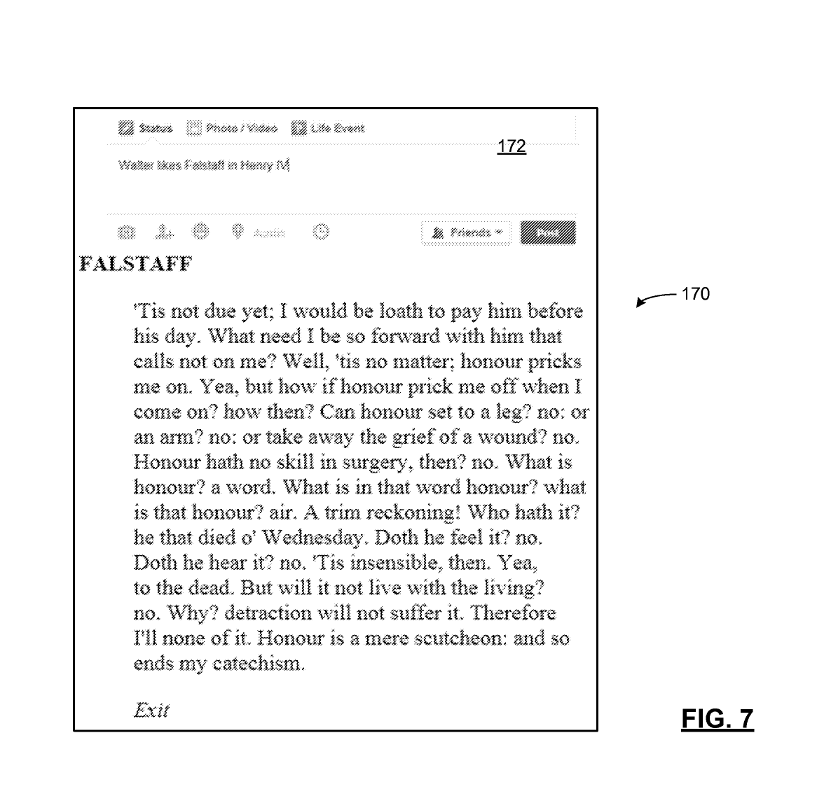

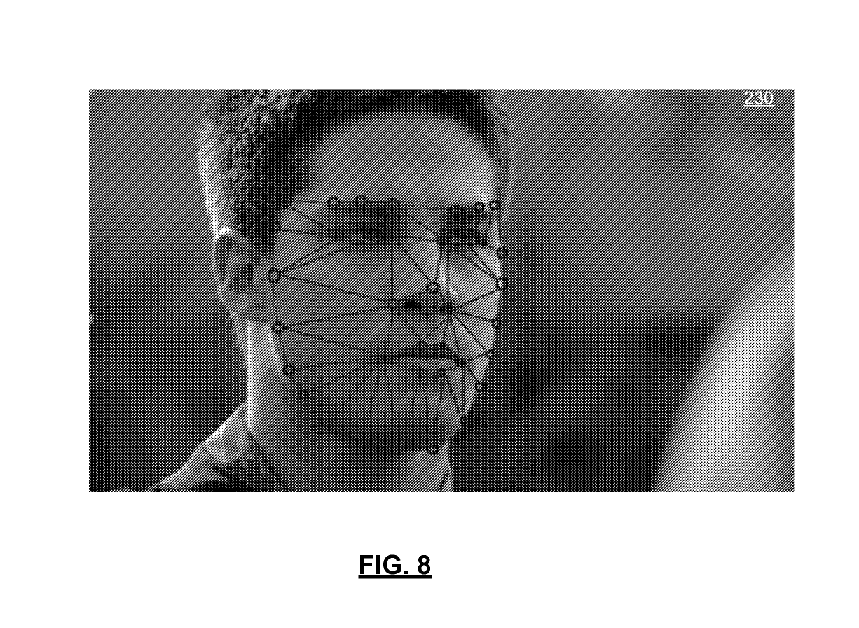

FIG. 8 presents a pictorial representation of a video image in accordance with an embodiment of the present disclosure. In particular, a screen display of image data 230 generated in conjunction with a system, such as system 125, is described in conjunction with functions and features of FIG. 5 that are referred to by common reference numerals.

In an embodiment, the user interest analysis generator 124 determines a period of interest corresponding to a viewer based on facial modeling and recognition that viewer has a facial expression corresponding to interest. The user interest analysis generator 124 analyzes the sensor data 108 to generate the control data 122. In an embodiment, the user interest analysis generator 124 analyzes the sensor data 108 to optionally determine the identity of the viewer and further to determine the user's level of interest in the current media content being presented or otherwise displayed. These factors can be used to determine the control data 122 via a look-up table, state machine, algorithm or other logic.

In one mode of operation, the user interest analysis generator 124 analyzes sensor data 108 in the form of image data together with a skin color model used to roughly partition face candidates. The user interest analysis generator 124 identifies and tracks candidate facial regions over a plurality of images (such as a sequence of images of the image data) and detects a face in the image based on the one or more of these images. For example, user interest analysis generator 124 can operate via detection of colors in the image data. The user interest analysis generator 124 generates a color bias corrected image from the image data and a color transformed image from the color bias corrected image. The user interest analysis generator 124 then operates to detect colors in the color transformed image that correspond to skin tones. In particular, user interest analysis generator 124 can operate using an elliptic skin model in the transformed space such as a C_{b}Cᵣ subspace of a transformed YC_{b}Cᵣ space. In particular, a parametric ellipse corresponding to contours of constant Mahalanobis distance can be constructed under the assumption of Gaussian skin tone distribution to identify a facial region based on a two-dimension projection in the C_{b}Cᵣ subspace. As exemplars, the 853,571 pixels corresponding to skin patches from the Heinrich-Hertz-Institute image database can be used for this purpose, however, other exemplars can likewise be used in broader scope of the present disclosure.

In an embodiment, the user interest analysis generator 124 tracks candidate facial regions over a sequence of images and detects a facial region based on an identification of facial motion and/or facial features in the candidate facial region over the sequence of images. This technique is based on 3D human face model that looks like a mesh that is overlaid on the face in the image data 230. For example, face candidates can be validated for face detection based on the further recognition by user interest analysis generator 124 of facial features, like eye blinking (both eyes blink together, which discriminates face motion from others; the eyes are symmetrically positioned with a fixed separation, which provides a means to normalize the size and orientation of the head), shape, size, motion and relative position of face, eyebrows, eyes, nose, mouth, cheekbones and jaw. Any of these facial features extracted from the image data can be used by user interest analysis generator 124 to recognize and analyze a viewer.

Further, the user interest analysis generator 124 can employ temporal recognition to extract three-dimensional features based on different facial perspectives included in the plurality of images to improve the accuracy of the detection and recognition of the face of each viewer. Using temporal information, the problems of face detection including poor lighting, partially covering, size and posture sensitivity can be partly solved based on such facial tracking. Furthermore, based on profile view from a range of viewing angles, more accurate and 3D features such as contour of eye sockets, nose and chin can be extracted.

In addition to detecting and identifying the particular viewer, the user interest analysis generator 124 can further analyze the face of the viewer/user to generate viewer interest data that indicates periods of viewer interest in particular content being displayed. In an embodiment, the image capture device is a back facing camera or is otherwise positioned so that an image of the viewer/user can be detected as they view the display device 105. In an embodiment the orientation of the face is determined to indicate whether or not the user is facing the display device 105 and whether the viewer is smiling. In this fashion, when the user's head is down or facing elsewhere, the user's level of interest in the content being displayed is low. Likewise, if the eyes of the user are closed for an extended period indicating sleep, the user's interest in the displayed content can be determined to be low. If, on the other hand, the user is facing the display device and/or the position of the eyes and condition of the mouth indicate a heighten level of awareness, the user's interest can be determined to be high.

For example, a user can be determined to be interested if the face is pointed at the display device 105 the mouth is smiling and the eyes are open or widely opened except during blinking events. Further other aspects of the face such as the eyebrows and mouth may change positions indicating that the user is following the display with interest. A user can be determined to be not watching closely if the face is not pointed at the display screen for more than a transitory period of time. A user can be determined to be engaged in conversation if the face is not pointed at the display screen for more than a transitory period of time, audio conversation is detected from the viewer that does not correlate to an excited utterance and appears to be unrelated to the content, the face is pointed away from the display device 105 and/or if the mouth of the user is moving consistently—indicating a possible conversation. A user can be determined to be sleeping if the eyes of the user are closed for more than a transitory period of time and/or if other aspects of the face such as the eyebrows and mouth fail to change positions over an extended period of time.

FIG. 9 presents a graphical diagram representation of interest data in accordance with an embodiment of the present disclosure. In particular, a graph of viewer interest data 75 as a function of time, generated in conjunction with a system, such as system 125, is described in conjunction with functions and features of FIG. 5 that are referred to by common reference numerals.

In this example, an analysis of input data is used by the user interest analysis generator 124 to generate binary viewer interest data 75 that indicates periods of time that the viewer has reached a high level of interest. In the example shown, the viewer interest data 75 is presented as a binary value with a high logic state (periods 262 and 266) corresponding to high interest and a low logic state (periods 260, 264 and 268) corresponding to a low level of interest or otherwise a lack of high interest.

In an embodiment, the timing of periods 262 and 266 can be correlated to metadata 114 and media 116 that is currently being displayed to generate recommendations data corresponding to the media content during these periods of high interest of the viewer. While the viewer interest data 75 is shown as a binary value, in other embodiments, viewer interest data 75 can be a multivalued signal that indicates a specific level of interest of the viewer and/or a rate of increase in interest of the viewer.

FIGS. 10 and 11 present pictorial diagram representations of components of a system in accordance with embodiments of the present disclosure. In particular, a pair of glasses/goggles 16 are presented that can be used to implement system 125 or a component of video system 125.

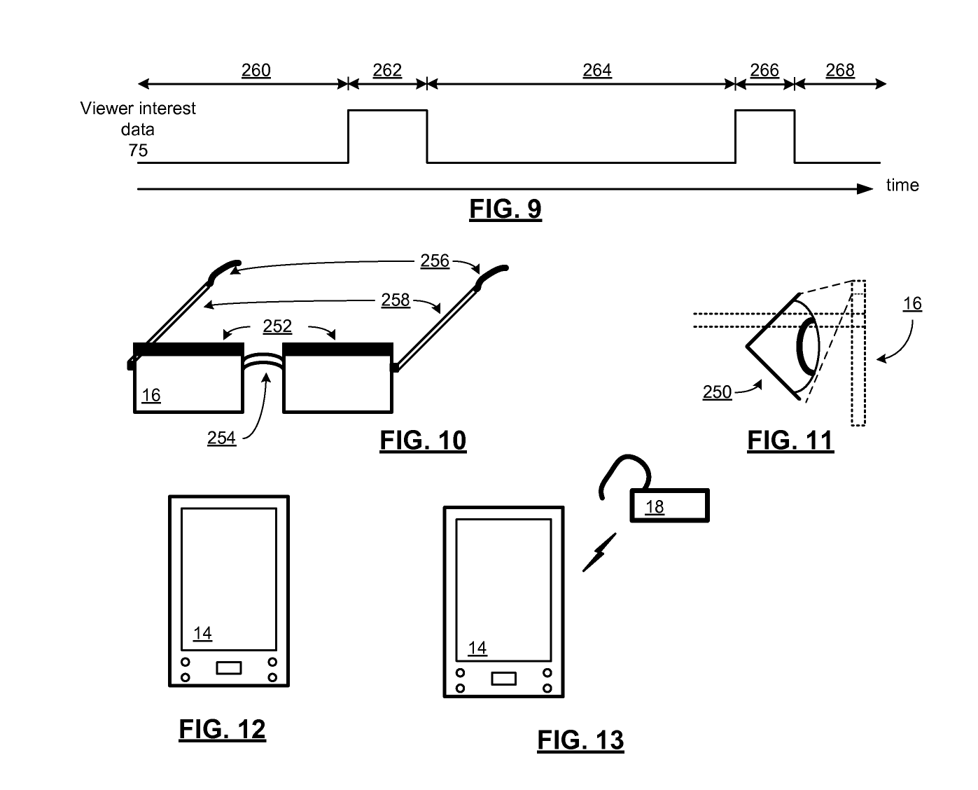

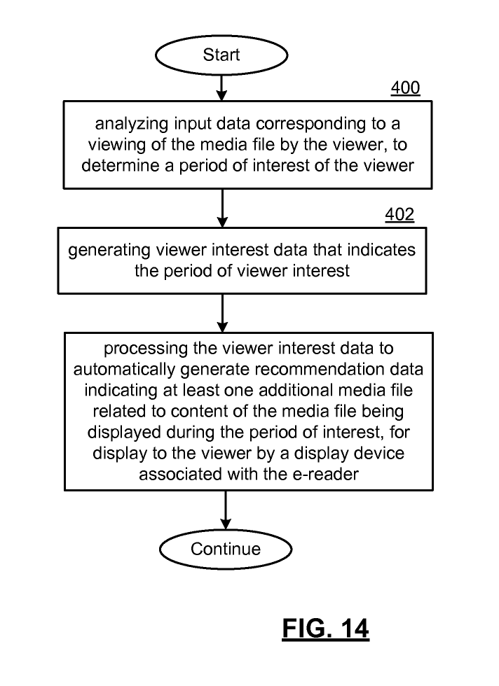

The glasses/goggles 16, such as head-up display glasses or goggles include viewer sensors 106 in the form of perspiration and/or viewer sensors incorporated in the nosepiece 254, bows 258 and/or earpieces 256 as shown in FIG. 12. In addition, one or more imaging sensors implemented in the frames 252 can be used to indicate eye wideness and pupil dilation of an eye of the wearer 250 as shown in FIG. 13.

In an embodiment, the glasses/goggles 16 further include a short-range wireless interface such as a Bluetooth or Zigbee radio that communicates sensor data 108 via a network interface 100 or indirectly via a portable device such as a smartphone, video camera, digital camera, tablet, laptop or other device that is equipped with a complementary short-range wireless interface. In another embodiment, the glasses/goggles 16 include the media reading module 104 with a heads up display that operates as display device 105, and some or all of the other components of the system 125.

FIGS. 12 and 13 present pictorial diagram representations of systems in accordance with embodiments of the present disclosure. In these embodiments, the smartphone 14 includes resistive or capacitive sensors in its cases that generate input data for monitoring heart rate and/or perspiration levels of the user as they grasp the device. Further the microphone or camera in each device can be used a viewer sensor 106 as previously described.

In yet another embodiment, a Bluetooth headset 18 or other audio/video adjunct device that is paired or otherwise coupled to the smartphone 14 can include resistive or capacitive sensors in their cases that generate input data for monitoring heart rate and/or perspiration levels of the user/viewer. In addition, the microphone in the headset 18 can be used to generate further input data that can be used by user interest analysis generator 124 in generating the viewer interest data 75.

FIG. 14 presents a flowchart representation of a method in accordance with an embodiment of the present disclosure. In particular, a method is presented for use in with one or more features described in conjunction with FIGS. 1-14. Step 400 includes analyzing input data corresponding to a viewing of the media file by the viewer, to determine a period of interest of the viewer. Step 402 includes generating viewer interest data that indicates the period of interest. Step 404 includes processing the viewer interest data to automatically generate recommendation data indicating at least one additional media file related to content of the media file being displayed during the period of interest, for display to the viewer by a display device associated with the e-reader.

In an embodiment, the input data includes image data of the viewer and wherein the period of interest is determined based on facial modeling of the viewer and recognition that the viewer has a facial expression corresponding to interest. The input data can also include sensor data from at least one biometric sensor associated with the viewer, and wherein the period of interest is determined based on recognition that the sensor data indicates interest of the viewer. The method can further include automatically generating a social media post associated with the viewer related to content of the media file being displayed during the period of interest and/or automatically generating advertising data related to content of the media file being displayed during the period of interest, for display to the viewer by a display device associated with the e-reader.

As used herein, a “user” of system 125 can be a “subscriber” to a service associated with the e-reader or ebook reader. The user of system 125 can be characterized as either a viewer or a reader when actually using the system to read or otherwise view media content via the device.

As may also be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”. As may even further be used herein, the term “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item.

As may also be used herein, the terms “processing module”, “processing circuit”, “processor”, and/or “processing unit” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, and/or processing unit may be, or further include, memory and/or an integrated memory element, which may be a single memory device, a plurality of memory devices, and/or embedded circuitry of another processing module, module, processing circuit, and/or processing unit. Such a memory device may be a read-only memory, random access memory, volatile memory, non-volatile memory, static memory, dynamic memory, flash memory, cache memory, and/or any device that stores digital information. Note that if the processing module, module, processing circuit, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, and/or processing unit executes, hard coded and/or operational instructions corresponding to at least some of the steps and/or functions illustrated in one or more of the Figures. Such a memory device or memory element can be included in an article of manufacture.

One or more embodiments have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality.

To the extent used, the flow diagram block boundaries and sequence could have been defined otherwise and still perform the certain significant functionality. Such alternate definitions of both functional building blocks and flow diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors executing appropriate software and the like or any combination thereof.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other by other activities not specifically shown. Further, while a flow diagram indicates a particular ordering of steps, other orderings are likewise possible provided that the principles of causality are maintained.

The one or more embodiments are used herein to illustrate one or more aspects, one or more features, one or more concepts, and/or one or more examples. A physical embodiment of an apparatus, an article of manufacture, a machine, and/or of a process may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

Unless specifically stated to the contra, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

The term “module” is used in the description of one or more of the embodiments. A module implements one or more functions via a device such as a processor or other processing device or other hardware that may include or operate in association with a memory that stores operational instructions. A module may operate independently and/or in conjunction with software and/or firmware. As also used herein, a module may contain one or more sub-modules, each of which may be one or more modules.

While particular combinations of various functions and features of the one or more embodiments have been expressly described herein, other combinations of these features and functions are likewise possible. The present disclosure is not limited by the particular examples disclosed herein and expressly incorporates these other combinations.

What is claimed is:

1. A system for use with a media reading module that displays a media file to a viewer, the system comprising:
a user interest analysis generator configured to analyze input data corresponding to a viewing of the media file by the viewer, to determine a period of interest of the viewer and to generate viewer interest data that indicates the period of interest; and
a recommendation selection generator configured to process the viewer interest data to automatically generate recommendation data indicating at least one additional media file related to content of the media file being displayed during the period of interest, for display to the viewer by a display device associated with the media reading module.

2. The system of claim 1 wherein the content of the media file being displayed during the period of interest includes a place and the recommendation selection generator identifies the at least one additional video program by searching a recommendation database based on the place.

3. The system of claim 1 wherein the content of the media file being displayed during the period of interest includes a character and the recommendation selection generator identifies the at least one additional video program by searching a recommendation database based on the character.

4. The system of claim 1 wherein the content of the media file being displayed during the period of interest includes a situation and the recommendation selection generator identifies the at least one additional video program by searching a recommendation database based on the situation.

5. The system of claim 1 wherein the input data includes image data of the viewer and wherein the user interest analysis generator determines the period of interest based on facial modeling of the viewer and recognition that the viewer has a facial expression corresponding to interest.

6. The system of claim 1 wherein the input data includes audio data in a presentation area of the system, and wherein the user interest analysis generator determines the period of interest based on recognition that utterances by the viewer correspond to interest.

7. The system of claim 1 wherein the input data includes control data from the system, and wherein the user interest analysis generator determines the period of interest corresponding to a pause in viewing by the viewer.

8. The system of claim 1 wherein the input data includes control data from the system, and wherein the user interest analysis generator determines the period of interest based on at least one repeated viewing by the viewer of the content of the media file being displayed.

9. The system of claim 1 wherein the input data includes sensor data from at least one biometric sensor associated with the viewer, and wherein the user interest analysis generator determines the period of interest based on recognition that the sensor data indicates interest of the viewer.

10. The system of claim 1 further comprising:
a network interface configured to communicate with a remote social media server; and
a social media generator configured to automatically generate a social media post associated with the viewer related to content of the media file being displayed during the period of interest.

11. The system of claim 1 further comprising:
an advertising generator configured to process the viewer interest data to automatically generate advertising data related to content of the media file being displayed during the period of interest, for display to the viewer by a display device associated with the media reading module.

12. The system of claim 1 wherein the media file includes metadata and wherein the recommendation selection generator identifies the at least one additional video program by searching a recommendation database based on the metadata.

13. The system of claim 12 wherein the metadata includes at least one if: highlighting by other users, highlighting by the viewer, annotations by other users, or annotations by the viewer.

14. A method for use with a media reading module that displays a media file to a viewer, the method comprising:
analyzing input data corresponding to a viewing of the media file by the viewer, to determine a period of interest of the viewer;
generating viewer interest data that indicates the period of interest; and
processing the viewer interest data to automatically generate recommendation data indicating at least one additional media file related to content of the media file being displayed during the period of interest, for display to the viewer by a display device associated with the media reading module.

15. The method of claim 14 wherein the input data includes image data of the viewer and wherein the period of interest is determined based on facial modeling of the viewer and recognition that the viewer has a facial expression corresponding to interest.

16. The method of claim 14 wherein the input data includes sensor data from at least one biometric sensor associated with the viewer, and wherein the period of interest is determined based on recognition that the sensor data indicates interest of the viewer.

17. The method of claim 14 further comprising:
automatically generating a social media post associated with the viewer related to content of the media file being displayed during the period of interest.

18. The method of claim 14 further comprising:
automatically generating advertising data related to content of the media file being displayed during the period of interest, for display to the viewer by a display device associated with the media reading module.
